(19) United States
(12) Patent Application Publication
(10) Pub. No.: US 2018/0236337 A1
(43) Pub. Date: Aug. 23, 2018

(54) Training Equipment for Athletic Skills

(71) Applicant: Rocky Frith, Jr., Magnolia, TX (US)

(72) Inventor: Rocky Frith, Jr., Magnolia, TX (US)

(21) Appl. No.: 15/429,423

(22) Filed: Feb. 22, 2017

(51) Int. Cl. A63B 69/00; A63B 21/00; A63B 21/06; A63B 21/065; G09B 19/00; A41D 19/00; A63B 23/12; A63B 41/08; A63B 41/00

(52) U.S. Cl. CPC A63B 69/0071; A63B 21/0004; A63B 21/00065; A63B 21/0603; A63B 21/065; G09B 19/0038; A63B 2209/10; A41D 19/0024; A63B 23/12; A63B 41/085; A63B 41/00; A63B 69/0059; A41D 19/002

(57) ABSTRACT

Sports training equipment for building fundamental skills of ball handling and control. The glove desensitizes the fingertips and causes the player to rely on the deeper muscle sensations for ball control. Weights on the mid-forearm enhance strength training without interfering with joints, and a removable ball cover adds unpredictability to further enhance a player's control and reaction.

### BACKGROUND OF THE INVENTION

This application pertains to sports training equipment, and particularly to equipment for training ball handling/control skills, and strength/stamina training. Forming ball control skills takes practice. One must build muscle strength and muscle memory to maintain control of the ball such that it becomes second nature to react to the ball's bounce without watching the ball.

Proper technique requires strength of the arm to push the ball down with the force of the wrist and the forearm in a controlled motion. The fingers should be spread to provide a balanced steady control, and the palm should not touch the ball. This can be told to new players repeatedly, but it is difficult to enforce when most training devices are supplemental as opposed to integral during the workout routine. Elite athletes, who already have good form, look for ways to differentiate from the rest. The only way to do this is to integrate unique training aids into the workout routine.

What is required is a training system which requires the player to utilize good technique and builds skill such that the play naturally improves when the training devices are removed from the player. This system should train the body more than just the brain such that the control is second nature to the player and they can concentrate on other aspects of the sport.

### BRIEF DESCRIPTION OF THE DRAWINGS

FIG. 1 illustrates a training glove being used in basketball handling in accordance with an exemplary embodiment of the invention.

FIG. 2 shows the hack side of the training glove in accordance with an exemplary embodiment of the invention.

FIG. 3A and 3B shows a front and side view of a palm flex plate in accordance with an exemplary embodiment of the invention.

FIG. 3 shows the palm side of the training glove in accordance with an exemplary embodiment of the invention.

FIG. 4 shows a side view of the training glove in accordance with an exemplary embodiment of the invention.

FIG. 5 illustrates a ball wrap in accordance with an exemplary embodiment of the invention.

### DETAILED DESCRIPTION OF THE PREFERRED EMBODIMENTS

Described herein is training equipment to build a player's handling technique and improve control of the ball. The sense of touch is controlled by the somatosensory system which consist of Mechanoreceptors, Thermoreceptors, Nocireceptors, and Proprioceptors.

We are primarily concerned with the Mechanoreceptors, which are further divided to Merkel's disks, Meissner's corpuscles, Ruffini's corpuscles, and Pacinian corpuscles, and Proprioceptors. Merkel's disks and Meissner's corpuscles are located throughout the ridges of the fingerprints.

Deeper in the dermis and along joints, tendons, and muscles are Ruffini's corpuscles and Pacinian corpuscles which feel sensations such as vibrations traveling down bones and tendons, rotational movement of limbs, and stretching of skin.

The training glove is built of a desensitizing material to improve the player's control by causing them to react to the pressure of the ball on the hand rather than the sense of the fingertips. One skilled in the arts would appreciate that materials could include, but not be limited to, elastic polyurethane (a.k.a. Lycra™), smooth leather, rough cut leather, thick fabric, sheepskin. That is, a material that mask the input of Merkel's disks and Meissner's corpuscles in the fingertips, in favor of greater input from Ruffini's and Pacinian corpuscles of the hand, wrist, and forearm.

The glove trains the user to depend on the deeper sensing in the muscles and joints rather than that of the fingertips. The glove also comprises several positioning features that train the proprioceptors, which sense the position of the different parts of the body in relation to each other.

The glove trains the user to keep the fingers spread and the palm concaved causing the ball to be controlled with the ends of the fingers. In one embodiment, a flex plate comprised of a non-yielding, concave material is positioned with the outward side toward the palm of the glove. This flex plate prevents the bail from touching the palm of the hand. In another embodiment, the flex plate is incorporated into the glove palm material which is concave shaped.

The glove also contains tensioning bands which run from an area near the fingertip, along the palm side of the finger and attach to the palm area biasing the glove into a concave shape. The tensioning bands are attached to a tension plate which can be adjusted by sliding against the flex plate, and secured by hook and loop fasteners or other means to adjust the tension on the fingers.

In another embodiment, the tensioning bands may be attached to the back side of the glove so the user must pull against them to form the concave shape of the hand. In another embodiment, the tensioning bands may be stiffeners pushing the fingers in the desired direction rather than utilizing a pulling motion. In one embodiment, the tensioners/stiffeners may be removably attached to the glove.

This tension causes the fingers to flex inward to form the concave shape, and allow for muscle strengthening by straightening the hand against the tension pressure. In another embodiment, the tensioning bands are connected through opening to a tensioning pad in a pocket incorporated into the palm. The pocket allows the flex plate to be removed from the glove for some exercises. In another embodiment, the pocket may be incorporated into the back of the glove to tensioners which run along the back of the hand. Tension bands may optionally be placed from the middle of the dorsal to the bottom of the weight zone to provide wrist tension. Similar tension bands can be added to other side of the wrist as well.

Wedges of material are secured between the fingers of the glove to spread the fingers and shape the hand. In another embodiment, the sides of the fingers have pockets incorporated therein which open toward the wrist. Spacers, which spring outward from a central point to form a V-like shape, are inserted into the pockets between the fingers and push the fingers apart. In another embodiment, the wedges secured between the fingers are air pockets which are inflated/deflated by the user to provide the spacing.

The gloves have a gathered wrist and elastic gathers on the back of the hand to produce a snug fit which prevents twisting and turning of the glove on the hand while in use. The gauntlet extends at least half way toward the elbow, and preferably to just under the elbow,

The end of the gauntlet is secured to the arm to prevent twisting and turning during use. A weight zone is in the middle of the forearm to which weights can be added to build the user's strength. Weights being positioned at the middle of the forearm cause the elbow and wrist to both strengthen during ball control drills. Weights only located at the wrist or the back of the hand interfere with the proper wrist movement.

The training glove is enhanced in training with a “wobbly-ball” cover. The ball cover fits snuggly around a standard sized sports ball and is closed around the ball with hook and loop fastener, or buttons, snaps, or a zipper. The cover has a plurality of protrusions which cause the surface of the sports ball to be uneven and distorted such that it will have an unpredictable action upon contact with the hand or the ground.

This unpredictable action causes the ball to be more difficult to control and thus enhances a player's training. One skilled in the art would appreciate that the elastic coefficient of the protrusions can be adjusted to affect the bounce direction without significant change in return velocity/bounce height.

In the preferred embodiment half spherical shaped protrusions of polybutadiene are affixed to the ball cover and aligned to equally space three protrusions per panel of a standard 8 panel basketball. In another embodiment, the protrusions are removable from the inside of the cover such that the cover, secured over the sports ball ensure remaining protrusions are sufficiently secured in place.

### DETAILED DESCRIPTION OF THE DRAWINGS

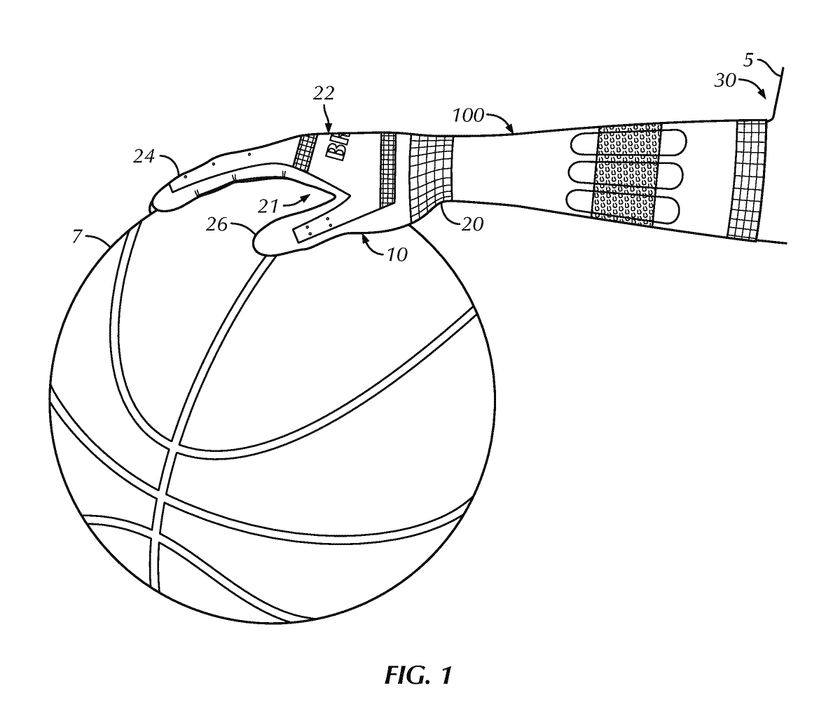

FIG. 1 illustrates a training glove being used in basketball handling in accordance with an exemplary embodiment of the invention. The training glove (100) is illustrated in the process of handling a basketball (7).

The glove (100) has a hand back (22) palm side (21) where the fingers (24) of the hand (10) curve, along with the thumb (26), to control the basketball (7) as the wrist (20) and arm (5) work together to produce a downward force, from the elbow joint (30), to bounce the basketball (7).

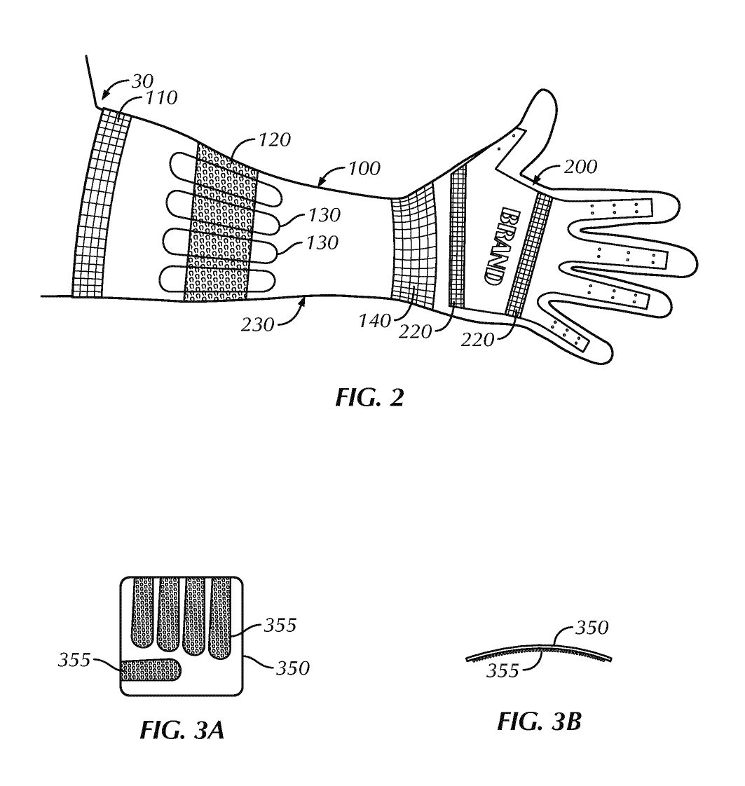

FIG. 2 shows the back side of the training glove in accordance with an exemplary embodiment of the invention. The training glove (100) is viewed from the back side of the hand (200). Elastic gathers (220) pull the glove (100) snug around the hand. A gathered wrist (140) provides freedom of motion on the wrist while securing the gauntlet (230) to the forearm.

The gauntlet (230) extends toward the elbow joint (30) where it is secured with a fastener strip (110). In the approximate middle of the forearm a weight zone (120) provides removably attached weights (130). Which are shown as attached with weights inserted into elastic pockets.

These weights (130) could also be inserted into pockets opening toward the elbow (30), or otherwise secured to prevent the weights (130) from slipping from the pocket, or they could be attached via hook and loop fasteners.

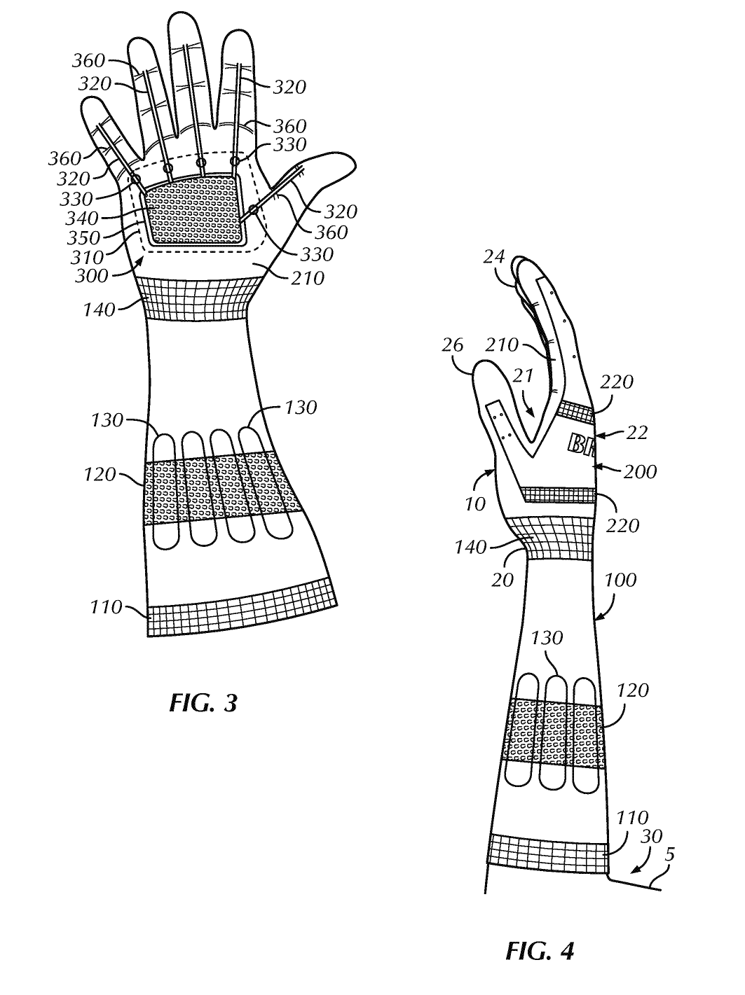

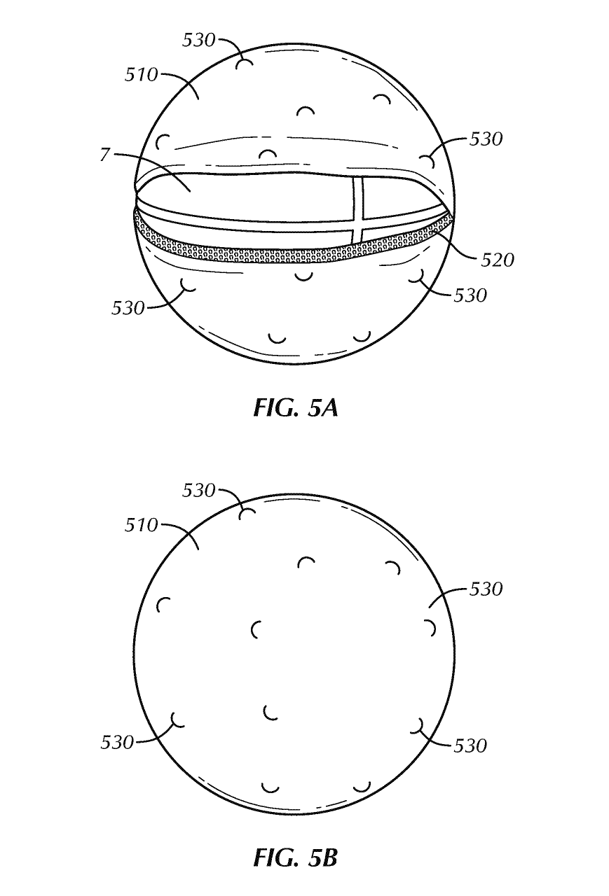

FIG. 3 shows the palm side of the training glove in accordance with an exemplary embodiment of the invention. The training glove (100) is viewed from the palm side of the hand (300). Visible on the forearm (5) are the weights (130) attached to the weight zone (120) and secured by the elastic wrist (140).

The palm has a plate pocket (310) into which is inserted the convex flex plate (350). The flex plate (350) is attached to the tensioning pad (340) via a hook and loop fastener (355, not shown). The tensioning pad (340) is attached to tensioning lines (320) which extend into the pocket (310) from the fingers (24) and thumb (26) through tensioner openings (330). The tensioning lines (320) are attached to the glove fingers (24) such that the hand can flex at the flex points (360).

FIG. 3A and 3B shows a front and side view of a palm flex plate in accordance with an exemplary embodiment of the invention. The flex plate (350) is a hard material which is concaved, and may be covered on at least one side with attachment means for the tensioner lines (320, not shown). The illustrated attachment means is the preferred embodiment and consist of hook and loop fasteners (355),

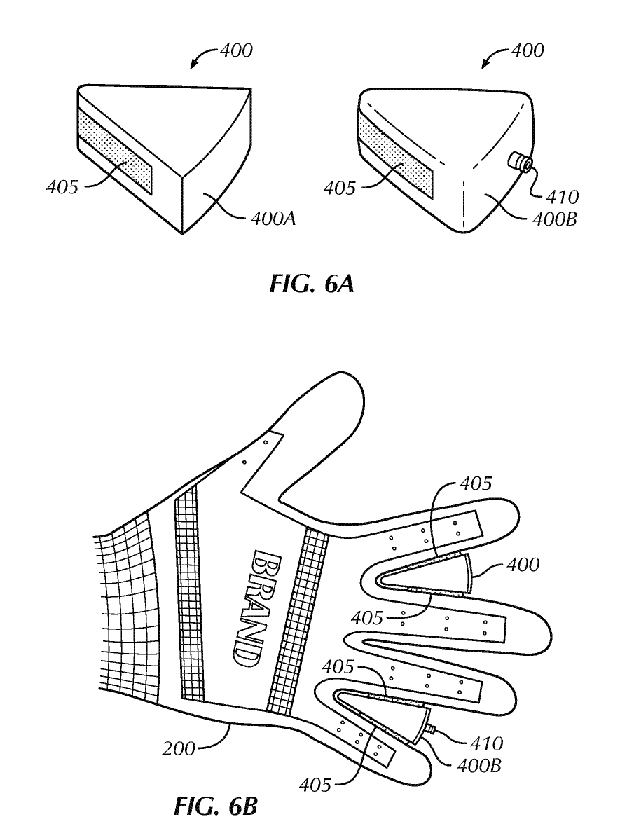

FIG. 4 shows a side view of the training glove in accordance with an exemplary embodiment of the invention. The fingers (34) and thumb (26) of the and (10) are covered with a glove comprised of a leather stiffener (210) which resist bending to force muscle action. The stiffener (210) also desensitizes the feelings of the fingertips to enhance feeling deeper in the arm tissue. Elastic gathers (220) tighten the glove around the hand, and coupled with the elastic wrist (140) over the wear's wrist (20) prevents movement on the hand.

The glove (100) extends up the arm (5) toward the elbow (30) where a fastening strap (110) secures the gauntlet (230), and positions the weigh attachment zone: (120) approximately mid-forearm. Weights (130) are removably attached thereto providing strength conditioning.

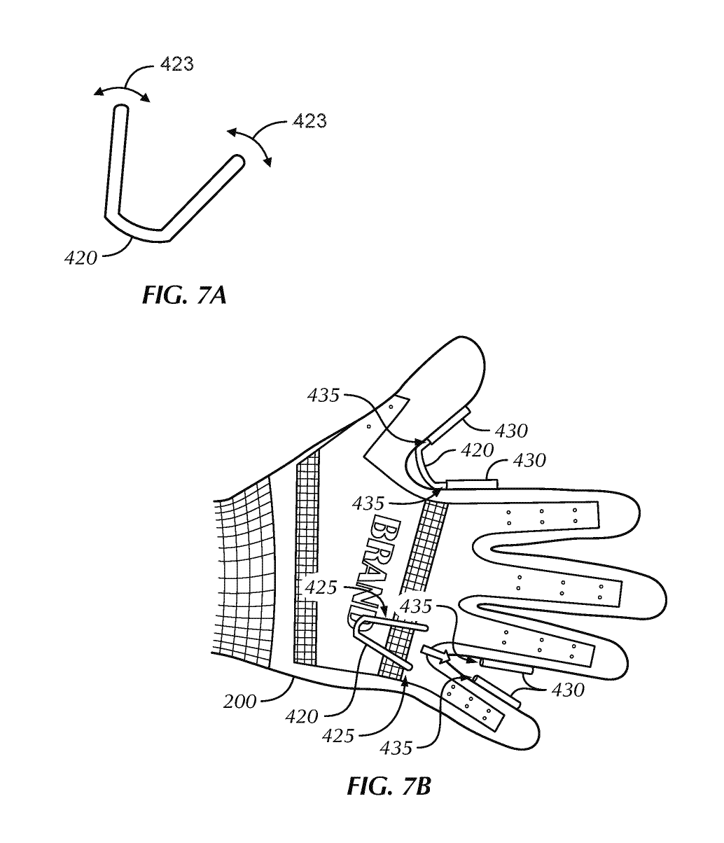

FIG. 5 illustrates a ball wrap in accordance with an exemplary embodiment of the invention. The sports ball, in this case a basketball (7) is enclosed in a material cover (510) which has a plurality of half spheres (530) spaced around the surface of the ball. These spheres cause an unpredictable bounce when the ball makes contact. Openings inside the cover (510) allow the protrusions (530) to be added or removed from the cover (510) and are secured by the basketball (7) being secured inside the cover (510).

The above discussion is meant to be illustrative of the principles and various embodiments of the present invention. Numerous variations and modifications will become apparent to those skilled in the art once the above disclosure is fully appreciated. It is intended that the following claims be interpreted to embrace all such variations and modifications.

1. A glove for sports training comprising;
a glove body having a gunn pattern with a wing thumb configuration and comprising a palm portion, five finger portions, a wrist portion, and a form fitting gauntlet extending over a wearer's forearm, at least half way to the wearer's elbow; including an arm opening configured to receive the wearer's hand, wherein the glove body includes a palmer surface and a dorsal surface;
the palmer surface further comprising a flex plate curving away from the palm on the edges; and
tensioning bands attached along the length of the palm side of the fingers; the tensioning bands being secured at the palm end to the flex plate.

2. The glove described in claim 1, further comprising:
the flex plate covered on one side in part of a hook and loop fastener material; and
tensioning bands palm end being secured to a removable tensioning pad, the tensioning pad being covered on one side with part of a hook and loop fastener material, and being repositionably attached to the flex plate via hook and loop fastener to adjust the tension applied along the fingers.

3. The glove described in claim 1, wherein the palmer surface comprises a desensitizing material to reduce the wearer's sense of touch.

4. (canceled)

5. The glove described in claim 2, further comprising a pocket in the palmer side having an opening toward the wrist and a plurality of tensioner opening at the finger end of the glove's palm area through which the tensioning bands extend to secure to the tensioning pad positioned against the removable flex plate, both being in the pocket.

6. (canceled)

7. (canceled)

8. The glove described in claim 1, further comprising:
the wrist portion gathering to produce a snug fit around the wrist;

9. The glove described in claim 1, further comprising:
the gauntlet further comprising a weight zone wherein removable weights are detachably connected to the gauntlet along the forearm.

10. The glove described in claim 9, wherein the weights are bags of loose material.

11. The glove described in claim 9, wherein the weights are inserted into pocketed one or more openings on the gauntlet.

12. The glove described in claim 1, further comprising:
the finger portions of the glove containing spreaders therebetween adjacent finger portions of the glove.

13. The glove described in claim 12, wherein the spreaders are removably affixed wedges of material.

14. The glove described in claim 12, wherein the spreaders are flexible springing V-shaped rods having the ends inserted into pockets on the sides of adjacent fingers of the glove.

15. The glove described in claim 1, further comprising:
the back side of the glove further comprising elastic gathers to improve fit and snugness of the glove along the hand.

16. A ball cover for sports training comprising;
a fabric cover sized to fit snugly around a sports ball;
the cover having a plurality of protrusions;
the protrusions deflecting the return trajectory of the sports ball upon contact with a surface.

17. The ball cover described in claim 16, further comprising:
a hook and loop fastener closing the cover around the ball.

18. The ball cover described in claim 16, wherein the protrusions are half-spherical in shape with the flat side oriented toward the sports ball's outer surface.

19. The ball cover described in claim 18, wherein the protrusions are rubber, polymer, or plastic.

20. The ball cover described in claim 18, wherein the protrusions have substantially a similar coefficient of restitution as the sports ball.
